(19) United States
(12) Patent Application Publication
(10) Pub. No.: US 2025/0020019 A1
(43) Pub. Date: Jan. 16, 2025

(54) RETRACTABLE GATE FENCE

(71) Applicant: Shenzhen Lute Jiacheng Supply Chain Management Co., Ltd., Shenzhen (CN)

(72) Inventors: Yiting CHEN, Shenzhen (CN); Hong XIE, Shenzhen (CN)

(73) Assignee: Shenzhen Lute Jiacheng Supply Chain Management Co., Ltd., Shenzhen (CN)

(21) Appl. No.: 18/446,691

(22) Filed: Aug. 9, 2023

(30) Foreign Application Priority Data
Jul. 13, 2023 (CN) 202321852633.6

(51) Int. Cl. E06B 9/13

(52) U.S. Cl. CPC E06B 9/13

(57) ABSTRACT

Disclosed is a retractable gate fence, referring to the technical field of gate fence. The retractable gate fence includes a spool and a pulling cloth, one end of the pulling cloth is connected to the spool. The pulling cloth has a first state that is wound onto the spool and a second state that is unfolded from the spool, and the pulling cloth is provided with a plurality of reinforcing strips at intervals.

### CROSS-REFERENCE TO RELATED APPLICATIONS

This application claims priority to Chinese Patent Application No. 202321852633.6, filed on Jul. 13, 2023, the entire contents of which are incorporated herein by reference.

### TECHNICAL FIELD

The present application relates to the technical field of gate fence, in particular to a retractable gate fence.

### BACKGROUND

A gate fence is installed at an exit such as of a room and can be used to prevent children or pets from leaving a certain place. A conventional retractable gate fence includes a spool, a pulling cloth and a winding mechanism, etc. The pulling cloth can be wound onto the spool or unfolded from the spool for use under the action of the winding mechanism. Nowadays, the pulling cloth of retractable gate fence on the market is usually made of soft cloth for the spooling of the pulling cloth. As the supporting strength of the soft cloth is weak, the pulling cloth is not sturdy and is easily to lose its shape when children and pets lean on it.

### SUMMARY

The main purpose of the present application is to provide a retractable gate fence, aiming to solve the technical problem that the supporting strength of a conventional retractable gate fence is weak, which will cause the pulling cloth to easily lose its shape.

In order to achieve the purpose above, the present application provides a retractable gate fence, the retractable gate fence includes a spool and a pulling cloth, one end of the pulling cloth is connected to the spool. The pulling cloth has a first state that is wound onto the spool and a second state that is unfolded from the spool, and a plurality of reinforcing strips are provided to the pulling cloth at intervals.

In one embodiment, the plurality of reinforcing strips are parallel to the spool.

In one embodiment, a separating distance is formed between two neighboring reinforcing strips, and two neighboring separating distances are not equal.

In one embodiment, two ends of each of the plurality of reinforcing strips are provided with protective cover.

In one embodiment, each of the plurality of reinforcing strips is provided as a whole or is provided in segments.

In one embodiment, the pulling cloth includes a first cloth strip and a second cloth strip stacked on the first cloth strip, and the plurality of reinforcing strips are embedded between the first cloth strip and the second cloth strip.

In one embodiment, the material of the first cloth strip and the second cloth strip is Oxford cloth.

In one embodiment, a plurality of pockets matching the plurality of reinforcing strips are provided being sewn between the first cloth strip and the second cloth strip, and the plurality of reinforcing strips are provided in the plurality of pockets.

In one embodiment, the plurality of reinforcing strips are detachably connected to the pulling cloth.

In one embodiment, an upper end of each of the plurality of pockets is provided with an opening, the plurality of reinforcing strips are inserted into the plurality of pockets from the opening to be detachably connected to the pulling cloth.

The pulling cloth of the conventional retractable gate fence is usually made of a soft cloth, but the supporting strength of the soft cloth is weak, so the pulling cloth is easily to lose its shape under an external force. In the technical solution of the present application, the pulling cloth is provided with a plurality of reinforcing strips at intervals. The reinforcing strips play a role of a skeleton to support the pulling cloth, thereby increasing the supporting strength of the pulling cloth. Thus, reinforcing strips not only can prevent the pulling cloth from becoming loose after the pulling cloth is unfolded, but also, the reinforcing strips can resist some of the external forces, and the pulling cloth can maintain a certain strength even though a child or pet presses against the pulling cloth.

### BRIEF DESCRIPTION OF THE DRAWINGS

In order to more clearly illustrate the technical solutions in the embodiments of the present application or in the prior art, drawings that are needed to illustrate the embodiments and the prior art are simply introduced below. Obviously, drawings introduced below are just some of the embodiments in the present application. For those of ordinary skill in the art, other figures may be further obtained without creative efforts according to the structures shown in drawings below.

FIG. 1 is a schematic structural view of a retractable gate fence being in a second state according to an embodiment of the present application.

The realization of the purpose, the functional feature, and the advantage of present application will be further illustrated referring to the drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all the embodiments of the present application. All other embodiments obtained by persons skilled in the art based on the embodiments of the present application without creative efforts shall fall within the scope of the present application.

It should be noted that all the directional indications (such as up, down, left, right, front, rear, etc.) in the embodiments of the present application are only used to explain the relative positional relationship, movement, or the like of the components in a certain posture (as shown in the drawings). If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. The meaning of “and/or” appearing in the disclosure includes three parallel scenarios. For example, “A and/or B” includes only A, or only B, or both A and B. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

A gate fence is installed at an exit such as of a room and can be used to prevent children or pets from leaving a certain place. A conventional retractable gate fence includes a spool, a pulling cloth and a winding mechanism, etc. The pulling cloth can be wound onto the spool or be unfolded from the spool for use under the action of the winding mechanism. Nowadays, the pulling cloth of retractable gate fence on the market is usually made of soft cloth for the spooling of the pulling cloth. As the supporting strength of the soft cloth is weak, the pulling cloth is not sturdy and is easily to lose its shape when children and pets lean on it.

To solve the above problem, a retractable gate fence 100 is introduced in the present application.

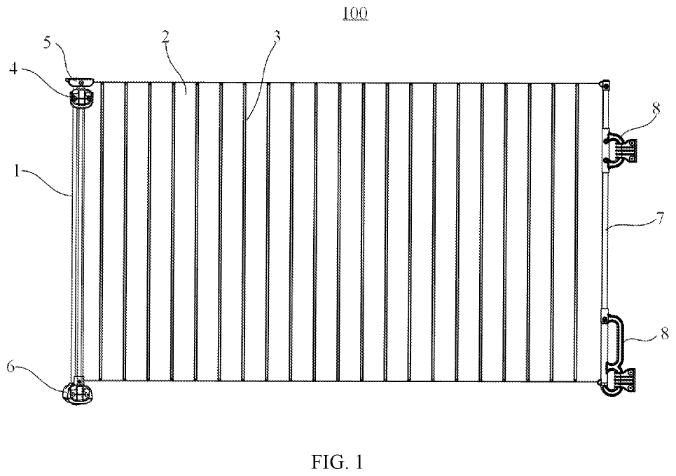

Referring to FIG. 1, the retractable gate fence 100 includes a spool 1 and a pulling cloth 2, one end of the pulling cloth 2 is connected to the spool 1. The pulling cloth 2 has a first state that is wound onto the spool 1 and a second state that is unfolded from the spool 1, and the pulling cloth 2 is provided with a plurality of reinforcing strips 3 at intervals.

The retractable gate fence 100 usually includes a spool 1, a pulling cloth 2 and a winding mechanism 4. An upper end of the spool 1 is provided with an upper spool seat 5, and a lower end of the spool 1 is provided with a lower spool seat 6. One end of the pulling cloth 2 is connected to the spool 1, and another end of the pulling cloth 2 is provided with a pulling rod 7, and the pulling rod 7 is provided with a pulling ring 8. The winding mechanism 4 is installed between the upper spool seat 5 and the lower spool seat 6 and is drivingly connected to the pulling cloth 2. When under the action of the winding mechanism 4, the pulling cloth 2 has a first state that is wound onto the spool 1 and a second state that is unfolded from the spool 1. When there is no need to set a gate fence, the pulling cloth 2 can be wound around the spool 1 to be in a wound state. And when it is needed to set a gate fence, pulling the pulling ring 8 and the pulling cloth 2 is unfolded under the pulling of the pulling rod 7, then hooking the pulling ring 8 to a hook or a nail at an edge of a door, and the pulling cloth 2 is set to block the door to play a protective role. The pulling cloth in the conventional retractable gate fence is usually made of a soft cloth, but the supporting strength of the soft cloth is weak, so the pulling cloth is easily to lose its shape under an external force. In the technical solution of present embodiment, the pulling cloth 2 is provided with a plurality of reinforcing strips 3 at intervals. The reinforcing strips 3 play a role of a skeleton to support the pulling cloth 2, thereby increasing the supporting strength of the pulling cloth 2. The reinforcing strips 3 not only can prevent the pulling cloth 2 from becoming loose after the pulling cloth 2 is unfolded, but also can resist some external forces, and the pulling cloth 2 can maintain a certain strength even though a child or pet presses against the pulling cloth 2. The reinforcing strips 3 can be wooden sticks, metal bars or plastic rods and the like.

In one embodiment, the plurality of reinforcing strips 3 are parallel to the spool 1, which facilitates the smooth winding and unfolding of reinforcing strips 3 along with the pulling cloth 2.

In one embodiment, a separating distance is formed between two neighboring reinforcing strips 3, and two neighboring separating distances are not equal.

It is easy to understand that if the plurality of reinforcing strips 3 are arranged at even intervals, i.e., all of the separating distances are the same. As the reinforcing strips 3 is wound around the spool 1, reinforcing strips 3 in the inner round and reinforcing strips 3 in the outer round will be stacked together, resulting in the pulling cloth 2 becoming uneven when the pulling cloth 2 is wound onto the spool 1. In order to avoid such problem, in the technical solution of the embodiment, two neighboring separating distances are designed to be not equal, which ensures that when the pulling cloth 2 is in the wound state, reinforcing strips 3 in the inner round and reinforcing strips 3 in the outer round are arranged at intervals from each other, thereby improving an evenness of the pulling cloth 2 when it is wound up.

In one embodiment, each of two ends of each of the plurality of reinforcing strips 3 is provided with a protective cover (not marked in drawings), which can prevent two ends of the reinforcing strip 3 from piercing the pulling cloth 2 or scratching users. The protective cover can be set as a cylindrical structure with an opening at one end. The material of the protective cover is plastic or silicone or the like.

In some embodiments of present application, each of the plurality of reinforcing strips 3 is provided as a whole to ensure the continuity of the reinforcing strips 3. In other embodiments of present application, each of the plurality of reinforcing strips 3 is provided in segments, i.e., reinforcing strip 3 at each parallel line is set intermittently, which ensures that the pulling cloth 2 has a certain flexibility while the reinforcing strips 3 play a role of a skeleton of the pulling cloth 2 to support the pulling cloth 2.

In one embodiment, the pulling cloth 2 includes a first cloth strip and a second cloth strip stacked on the first cloth strip, and the plurality of reinforcing strips 3 are embedded between the first cloth strip and the second cloth strip.

The pulling cloth of a conventional retractable gate fence is usually a single layer fabric. In the embodiment, the pulling cloth 2 is set into two layers to accommodate with reinforcing strips 3. The two layers include a first cloth strip and a second cloth strip, the first cloth strip and the second cloth strip are of the same size and are sewn into a single piece by sewing process, and the plurality of reinforcing strips 3 are embedded between the first cloth strip and the second cloth strip. The plurality of reinforcing strips 3 may be glued or sewn into the first cloth strip and the second cloth strip, such that the plurality of reinforcing strips 3 is hidden between the first cloth strip and the second cloth strip, and the beauty of the product is improved.

In one embodiment, the first cloth strip and the second cloth strip are made of Oxford cloth.

The pulling cloth in conventional retractable gate fence is typically made of polyvinyl chloride (PVC) mesh, which has been proven to be extremely easy to be scratched by children or pets. To solve this problem, the first cloth strip and the second cloth strip in the embodiment are made of Oxford cloth, which is made of polyester and nylon and has a great abrasion resistance, and can withstand prolonged use and friction, so as to prolong the service life of the pulling cloth 2.

When the plurality of reinforcing strips 3 are sewn to the first cloth strip and the second cloth strip, a plurality of pockets matching the plurality of reinforcing strips 3 are sewn between the first cloth strip and the second cloth strip, and the plurality of reinforcing strips 3 are provided in the plurality of pockets.

In the sewing process of the first cloth strip and the second cloth strip, the reinforcing strip 3 can be sewn in an interlayer of the first cloth strip and the second cloth strip. That is, the reinforcing strip 3 is provided at a preset position in the interlayer. Then the stitching is carried out around four edges of the reinforcing strip 3, so as to seal the reinforcing strip 3 into a pocket enclosed by four stitches, and to realize the installation of the reinforcing strip 3.

In one embodiment, the plurality of reinforcing strips 3 are detachably connected to the pulling cloth 2. An upper end of each of the plurality of pockets is provided with an opening, the plurality of reinforcing strips 3 are inserted into the plurality of pockets from the opening to be detachably connected to the pulling cloth 2.

In the above embodiment, it is not necessary to sew the reinforcing strip 3 into the interlayer of the first cloth strip and the second cloth strip when the first cloth strip and the second cloth strip are sewn together, but rather, the plurality of pockets matching the plurality of reinforcing strips 3 are sewn between the first cloth strip and the second cloth strip in advance. The pocket is enclosed by three sides with an opening at the upper end, and then each of the plurality of reinforcing strips 3 can be inserted into each of the plurality of pockets from the opening. The upper end refers to one end of the pulling cloth 2 that faces upwards when the pulling cloth 2 is unfolded for use. In the embodiment, the plurality of reinforcing strips 3 is detachably connected to the pulling cloth 2, if one of the reinforcing strips 3 breaks, it can be pulled out and replaced.

The above-mentioned embodiments are only some embodiments of the present application, and are not intended to limit the scope of the present application. Any equivalent structure conversion made with reference to the description and the accompanying drawings of the present application, direct or indirect application in other related technical fields, should all fall in the scope of the present application.

What is claimed is:

1. A retractable gate fence, comprising:
a spool and a pulling cloth,
wherein one end of the pulling cloth is connected to the spool, and the pulling cloth has a first state that is wound onto the spool and a second state that is unfolded from the spool; and
the pulling cloth is provided with a plurality of reinforcing strips at intervals.

2. The retractable gate fence according to claim 1, wherein the plurality of reinforcing strips are parallel to the spool.

3. The retractable gate fence according to claim 2, wherein a separating distance is formed between two neighboring reinforcing strips, and two neighboring separating distances are not equal.

4. The retractable gate fence according to claim 1, wherein each of two ends of each of the plurality of reinforcing strips is provided with a protective cover.

5. The retractable gate fence according to claim 1, wherein each of the plurality of reinforcing strips is provided as a whole or is provided in segments.

6. The retractable gate fence according to claim 1, wherein the pulling cloth comprises a first cloth strip and a second cloth strip stacked on the first cloth strip, and the plurality of reinforcing strips are embedded between the first cloth strip and the second cloth strip.

7. The retractable gate fence according to claim 6, wherein the first cloth strip and the second cloth strip are made of Oxford cloth.

8. The retractable gate fence according to claim 6, wherein a plurality of pockets matching the plurality of reinforcing strips are sewn between the first cloth strip and the second cloth strip, and the plurality of reinforcing strips are provided in the plurality of pockets.

9. The retractable gate fence according to claim 8, wherein the plurality of reinforcing strips are detachably connected to the pulling cloth.

10. The retractable gate fence according to claim 9, wherein an upper end of each of the plurality of pockets is provided with an opening, and the plurality of reinforcing strips are inserted into the plurality of pockets from the opening to be detachably connected to the pulling cloth.
